(19) United States
(12) Patent Application Publication
(10) Pub. No.: US 2021/0166085 A1
(43) Pub. Date: Jun. 3, 2021

(54) Object Classification Method, Object Classification Circuit, Motor Vehicle

(71) Applicant: Volkswagen Aktiengesellschaft, Wolsburg (DE)

(72) Inventors: Peter Schlicht, Wolfsburg (DE); Nico Maurice Schmidt, Berlin (DE)

(73) Assignee: Volkswagen Aktiengesellschaft, Wolfsburg (DE)

(21) Appl. No.: 17/107,326

(22) Filed: Nov. 30, 2020

(30) Foreign Application Priority Data
Nov. 29, 2019 (DE) 10 2019 218 613.0

(51) Int. Cl. G06K 9/62; G06K 9/00; G06N 3/08

(52) U.S. Cl. CPC G06K 9/6268; G06N 3/08; G06K 9/00791; G06K 9/6215

(57) ABSTRACT

The present invention relates to an object classification method, comprising: classifying an object based on sensor data from a sensor, wherein the classification is based on a training of an artificial intelligence, wherein the training comprises: obtaining first sensor data which are indicative of the object; obtaining second sensor data which are indicative of the object, wherein a partial symmetry exists between the first and second sensor data; detecting the partial symmetry; and creating an object class based on the detected partial symmetry.

### CROSS-REFERENCE TO RELATED APPLICATIONS

This application claims priority to German Patent Application No. 10 2019 218 613.0, filed on Nov. 29, 2019 with the German Patent and Trademark Office. The contents of the aforesaid patent application are incorporated herein for all purposes.

### TECHNICAL FIELD

The invention relates to an object classification method, an object classification circuit, and a motor vehicle.

### BACKGROUND

This background section is provided for the purpose of generally describing the context of the disclosure. Work of the presently named inventor(s), to the extent the work is described in this background section and other sections, as well as aspects of the description that may not otherwise qualify as prior art at the time of filing, are neither expressly nor impliedly admitted as prior art against the present disclosure.

Object classification methods are generally known which are based on an artificial intelligence or which are performed by an artificial intelligence.

Such methods may be used, for example, in automated driving, in driver assistance systems and the like.

Deep neural networks may process raw sensor data (for example from a camera, radar, lidar) in order to derive relevant information therefrom.

Such information may relate, for example, to a type, a position, a behavior of an object, and the like. In addition, a vehicle geometry and/or a vehicle topology may also be detected.

Typically, data-driven parameter fitting is carried out when training a neural network.

In such data-driven parameter fitting, a deviation (loss) of an output from a basic truth (ground truth) is established, for example with a loss function. The loss function may be selected such that the parameters to be fit are differentiably dependent on it.

A gradient descent may be applied to such a loss function in which at least one parameter of the neural network is adapted in a training step depending on the derivation (in the sense of a mathematical differentiation) of the loss function.

Such a gradient descent may be repeated (as often as specified) until no further improvement of the loss function is achieved or until an improvement of the loss function is below a specified threshold.

However, for such known networks, the parameters are typically established without an expert assessment and/or without semantically motivated modeling.

This may lead to such a deep neural network being nontransparent for an expert and a calculation of the network being uninterpretable (or only interpretable with difficulty).

This may lead to the problem that systematic testing and/or a formal verification of the neural network may not be able to be performed.

Furthermore, a known deep neural network may be susceptible to an interference (adversial perturbation) so that an incremental change in an input may lead to a pronounced change in an output.

In addition, it is not clear in all cases of known neural networks which input features are considered, meaning that synthetic data may not be able to be used in known neural networks, or if it is used, it could lead to relatively weak performance. Furthermore, executing a known neural network in a different domain (for example, training in summer but execution in winter) may lead to weak performance.

It may be generally known to train a neural network with diverse (different) data sets, wherein the data sets may have different contexts, different sources (for example, simulation, real data, different sensors, augmented data). However, in this case partial symmetry between the different data sets is typically not detected.

In addition, transfer learning and domain adaptation may be known. In this case, an algorithm may be adapted to a (not further controlled) new domain through additional training and special selection of a loss function. For this purpose, for example, a neural network may be desensitized with regard to different domains or through focused follow-up training with a limited number of training examples from the target domain.

However, in this case an object class may not be created expediently.

### SUMMARY

An object exists to provide an object classification method, an object classification circuit, and a motor vehicle which at least partially overcomes the disadvantages mentioned above.

The object is achieved by an object classification method of, an object classification circuit, and by a motor vehicle according to the independent claims. Embodiments of the invention are discussed in the dependent claims and the following description.

According to a first exemplary aspect, an object classification method comprises: classifying an object based on sensor data from a sensor, wherein the classification is based on a training of an artificial intelligence, and wherein the training comprises: obtaining first sensor data which are indicative of the object; obtaining second sensor data which are indicative of the object, wherein a partial symmetry exists between the first and second sensor data; detecting the partial symmetry; and creating an object class based on the detected partial symmetry.

According to a second exemplary aspect, an object classification circuit is configured to carry out an object classification method according to the first exemplary aspect.

According to a third exemplary aspect, a motor vehicle has an object classification circuit according to the second exemplary aspect.

The details of one or more exemplary embodiments are set forth in the accompanying drawings and the description below. Other features will be apparent from the description, drawings, and from the claims.

### BRIEF DESCRIPTION OF THE DRAWINGS

FIG. 1 schematically shows an exemplary embodiment of an object classification method in a block diagram; and

FIG. 2 shows a motor vehicle in a block diagram.

### DESCRIPTION

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

Known methods for object classification have the disadvantage that they may be inexact, for example in that no partial symmetry of different data sets (for example sensor data) is detected in a training.

However, it has been recognized that detecting a partial symmetry may lead to improved results in an object classification.

Moreover, it has been recognized that known solutions require a large data set and scaling to different domains may possibly not be demonstrated or only with a large amount of effort (e.g. complex algorithms, high computing power, time expenditure).

In addition, it is desirable to improve performance and correctness of an object classification.

Some exemplary embodiments therefore relate to an object classification method comprising:

classifying an object based on sensor data from a sensor, wherein the classification is based on a training of an artificial intelligence, wherein the training comprises:

obtaining first sensor data which are indicative of the object; obtaining second sensor data which are indicative of the object, wherein a partial symmetry exists between the first and second sensor data; detecting the partial symmetry; and creating an object class based on the detected partial symmetry.

The classification may comprise applying an algorithm, accessing from a storage device or from a database, and the like. The classification may be based on an output, a result, and the like which occurs in reaction to a measurement of a sensor (for example, a camera of a motor vehicle).

The algorithm, the database, the storage device, and the like may be created by an artificial intelligence so that, in an application of the learned object classification method, it is not necessary for the artificial intelligence to be present on a system, as a result of which storage capacity and computing power may beneficially be saved.

In addition, it is beneficial that enough time may be available in a training.

The artificial intelligence (AI) may use, for example, methods based on machine learning, deep learning, explicit feature, and the like, such as pattern recognition, edge detection, a histogram-based method, pattern matching, color match, and the like.

This results in the benefit that known methods for generating an AI may be used.

In some exemplary embodiments, the learning algorithm comprises machine learning.

In such exemplary embodiments, the learning algorithm may be based on at least one of the following:

scale-invariant feature transform (SIFT), gray-level co-occurrence matrix (GLCM), and the like.

In addition, the machine learning may be based on a classification method such as at least one of the following: random forest, support vector machine, neural network, Bayesian network, and the like, wherein such deep learning methods may be based, for example, on at least one of the following: autoencoder, generative adversarial network, weakly supervised learning, bootstrapping, and the like.

Furthermore, the machine learning may also be based on data clustering methods such as density-based spatial clustering of applications with noise (DBSCAN), and the like.

The supervised learning may also be based on a regression algorithm, a perceptron, a Bayes classification, a Naive Bayes classification, a nearest neighbor classification, an artificial neural network, and the like.

Thus, known methods for machine learning may beneficially be used.

In some exemplary embodiments, the AI may comprise a convolutional neural network.

The object may be any object, for example it may be an object that is relevant in a context. For example, in the context of street traffic, a relevant object (or an object class) may be a (motor) vehicle, a pedestrian, a street sign, and the like, while in the context of augmented reality, a relevant object may be a user, a piece of furniture, a house, and the like.

The training of the artificial intelligence may comprise obtaining first sensor data (of the sensor). The sensor may, for example, perform a measurement which is transferred, for example, to a processor (for the AI), for example in reaction to a query of the processor (or the AI). In some exemplary embodiments, the first sensor data may also be present on a storage device to which the AI may have access.

The first sensor data may be indicative of the object, i.e. that a measurement by the sensor is aimed, for example, at the object so that the object may be derived from the first sensor data. The sensor may be, for example, a camera and the AI may be trained for an object recognition on the basis of image data. In such exemplary embodiments, the object may be placed in an optical plane which is registered by the camera.

In addition, second sensor data may be obtained in a similar (or identical) way as the first sensor data or in a different way. For example, the first sensor data may be present in a storage device, while the second sensor data may be transferred directly from a measurement to the AI, or vice versa. The second sensor data may originate from the same sensor as the first sensor data, but the present invention is not intended to be limited to this. For example, a first sensor may be a first camera and a second sensor may be a second camera. In addition, the present invention is also not limited to the first and the second sensors being of the same sensor type (for example, a camera). The first sensor may be, for example, a camera, while the second sensor may be a radar sensor, and the like.

A partial symmetry may exist between the first and second sensor data. For example, characteristics and/or a behavior of the object and/or its environment which are indicated by the first and second sensor data may be the same or similar.

For example, a first image of the object in a first illumination situation (for example, light on) may be captured by a camera, whereby first sensor data are generated, whereupon a second image of the object in a second illumination situation (for example, light off) may be captured, whereby second sensor data are generated. In this case, the partial symmetry may be the object (and/or additional objects). Depending on the (additional) sensor, the partial symmetry may also comprise an air pressure, a temperature, a position, and the like.

The partial symmetry may be detected, for example, on the basis of a comparison between the first and the second sensor data, wherein an object class for the object classification is created on the basis of the detected partial symmetry, wherein an algorithm may also be created in some exemplary embodiments to perform an object classification (or an object detection).

Due to the partial symmetry, a function (similarly to the loss function described above) may be developed.

Here, the fact that there may be a series, a set, a plurality, and the like of transformations (or changes) in the possible input space which the output of the AI cannot change or may only change below a specified threshold may be taken advantage of.

In this context, the classification may comprise assigning a detected object to (and/or associating it with) the object class.

For example, it may have been detected that an object is located in a field of view of a camera. By classifying the object, it may be determined what type of object it is. For example, the object may be classified as a motor vehicle.

Thus, an identification of a detected object may beneficially take place that goes beyond simply detecting the object.

Typically, the object class does not have to have a concrete name (such as motor vehicle), since the object class is determined by the artificial intelligence. In this respect, the object class may exist as an abstract data set.

In some exemplary embodiments, the artificial intelligence comprises a deep neural network, as described herein.

This results in the benefit that it is not necessary to perform supervised learning, making automation possible.

In some exemplary embodiments, the second sensor data are based on a change in the first sensor data.

The change may be an artificial change in the first sensor data. For example, a manipulation of a source code, a bit, a bit sequence, and the like of the first sensor data may lead to the second sensor data. However, the present aspect is not limited to a manipulation of the first sensor data since, as discussed above, a second capture (or measurement) by the sensor (or by a second sensor) may be made in order to obtain second sensor data.

In some exemplary embodiments, the change comprises at least one of the following: image data change, semantic change and dynamic change.

An image data change may comprise at least one of the following: contrast change (for example, contrast shift), color change, color depth change, image sharpness change, brightness change (for example, brightness adjustment), sensor noise, position change, rotation, and distortion.

The sensor noise may be an artificial or natural noise with any power spectrum. The noise may be simulated by a voltage applied to the sensor, but may also be achieved through sensor data manipulation. The noise may comprise, for example, Gaussian noise, salt-and-pepper noise, Brownian noise, and the like.

The position change as well as the rotation (of the sensor, of the object, and/or of its environment) may lead to the object being measured or captured from a different angle.

The distortion may be caused, for example, by using another sensor, by at least one other lens, and the like.

This has the benefit that the number of inputs to the AI may be increased so that the partial symmetry may be more exactly determined, allowing a more exact object classification to be achieved.

A semantic change may comprise at least one of the following: change in illumination, change in weather conditions, and change in object characteristics.

The change in weather conditions may comprise, for example, a change in an amount of precipitation, a type of precipitation, an intensity of the sun, a time of day, an air pressure, and the like.

The object characteristics may comprise, for example, color, clothing, type, and the like.

A semantic change may generally be understood to mean a change in a context in which the object is located, such as also an environment. For example, the object may be located in a house in the first sensor data, while it is located in a field in the second sensor data.

This has the benefit that the number of inputs to the AI may be increased so that the partial symmetry may be more exactly determined, allowing a more exact object classification to be achieved.

A dynamic change may comprise at least one of the following: acceleration, deceleration, motion, change in weather, and change in illumination situation.

An acceleration and/or a deceleration may lead to a different sensor impression than a constant motion (or none at all) of the sensor or of the object and/or of its environment, for example an influence of the Doppler effect may have a relevant effect depending on the speed and/or acceleration.

This has the benefit that the number of inputs to the AI may be increased so that the partial symmetry may be more exactly determined, allowing a more exact object classification to be achieved.

In the event of such changes (or transformation of the input space), the AI may be configured to deliver a constant result.

To detect a partial symmetry, a parameterization step of the AI may be interspersed during the training. In such a parameterization step, an existing sensor impression (first sensor data) is changed so that second sensor data arise which may be processed together with the first sensor data. A difference in the results of the processing of the first sensor data and the second sensor data may be assessed as an error, since it is assumed that the result should be constant (or should not change in the second sensor data with regard to the first sensor data). Due to the error, a parameter of the AI (or a network parameter of a neural network) may be adapted so that the same result may be delivered in the case of repeated processing.

Training data may be used here, meaning data which comprise the object to be classified, as well as other sensor data (without a “label”).

This results from the fact that the partial symmetry is trained and not a function of the AI.

Thus, this results in the benefit that no ground truth is necessary to train the AI.

In some exemplary embodiments, the change is based on a sensor data change method.

With a sensor data change method, a sensor impression that is presented to the AI may beneficially be changed to enable an optimized determination of the partial symmetry.

The sensor data change method may comprise at least one of the following: image data processing, sensor data processing, style transfer network, manual interaction, and repeated data capture.

With image and/or sensor data processing, a brightness adjustment, a color saturation adjustment, a color depth adjustment, a contrast adjustment, a contrast normalization, an image crop, an image rotation, and the like may be applied.

A style transfer network may comprise a trained neural network for changing specific image characteristics (for example, a change from day to night, from sun to rain, and the like).

Thus, the training may beneficially be performed in a time-optimized manner and a plurality of image characteristics may be considered without them having to be set them manually (or in reality) (which, for example due to weather conditions, may not be easily possible in some circumstances).

In a manual interaction, a semantically irrelevant portion of the first sensor data may be changed manually.

If data is captured once again, as explained above, the second sensor data may be based on a repeated measurement, wherein, for example, a sensor unit may be changed (for example, a different sensor than the one that captures the first sensor data), and/or wherein, for example, content (for example, a change in the environment) is changed, and/or wherein a simulation condition is changed.

In some exemplary embodiments, the change may also be based on a combination of at least two sensor data change methods.

For example, a certain number of iterations (or hyperparameters) may be provided in which a style transfer network is applied and a certain number of iterations in which a repeated data capture is applied.

One of the two (or both) methods may then be used to determine partial symmetry.

This results in the benefit that the AI is stable and agnostic in relation to changes that do not change the output.

Furthermore, this has the benefit that the number of inputs to the AI may be increased so that the partial symmetry may be determined more exactly, allowing a more exact object classification to be achieved.

This has also the benefit that improved functionality may be achieved, for example through memorization of objects, overfitting, and the like.

After convergence of the training has occurred (i.e. when the output remains constant), the AI may be able to carry out a function (such as an object classification) while it is also beneficially able to differentiate a relevant change from an irrelevant change of the sensor data.

This has also the benefit that the learned function may be transferred to another application domain (for example, change in the object classes, adaptation of the surroundings, and the like), for example with a transfer learning algorithm, and the like.

This has the benefit that a conceptual domain adaptation of a neural network is possible.

In some exemplary embodiments, the change is also based on at least one of the following: batch processing, variable training increment, and variable training weight.

In batch processing, multiple sensor impressions may be obtained during one iteration, for example the first and second sensor data may be obtained simultaneously, wherein various symmetries may be detected for each sensor impression. Thus, an overall iteration error may be determined to which the AI may be correspondingly adapted or adapts itself, which brings with it the advantage of a more exact object classification.

With a variable (adaptive and/or different) training increment and a variable (to be adapted) training weight, the learning rate with which parameters of the AI are adapted may be adapted individually for each training input. For example, a learning rate for a change on the basis of a style transfer network may be set higher than for a change on the basis of a manual interaction, and the like.

In addition, the learning rate may be adapted independently of a level of training progress.

Moreover, weights which are created in each training step may only be adapted to network layers (of a neural network) which are located close to the input.

In some exemplary embodiments, the training also comprises: detecting an irrelevant change in the second sensor data with regard to the first sensor data; and marking the irrelevant change as an error to detect the partial symmetry.

The irrelevant change may be based on a difference (for example, based on a comparison) of the second sensor data with regard to the first sensor data (or vice versa) which is assessed by the AI as an error so that the partial symmetry (for example, a similarity of the first and second sensor data) may be detected.

In some exemplary embodiments, the sensor comprises at least one of the following: camera, radar, and lidar, as described herein.

The present invention is not, however, limited to this type of sensors, since in principle it may be applied for any sensor which is suitable for object detection or classification, such as a time-of-flight sensor, and other sensors which may capture or determine an image, a distance, a depth, and the like.

Thus, this has the benefit of a universal applicability of the present teachings, since it may be used in all areas in which an AI, in particular with a deep learning capability, is used which evaluates sensor data, such as in the areas of medical technology, medical robotics, (automatic) air, rail, ship, space travel, (automatic) street traffic, vehicle interior observation, production robotics, AI development, and the like.

In some exemplary embodiments, the error (and therefore the partial symmetry) may also be determined on the basis of differences in intermediate calculations of the AI (for example, activation patterns of network layers of a neural network) between first and second sensor data which are changed in various ways.

Some exemplary embodiments relate to an object classification circuit which is configured to carry out an object classification method according to the first aspect and/or the embodiments, discussed in the preceding.

The object classification circuit may comprise a processor, such as a CPU (central processing unit), a GPU (graphics processing unit), an FPGA (field-programmable gate array) as well as a data storage device, a computer, one (or more) server(s), a control device, a central on-board computer, and the like, wherein combinations of the mentioned elements are also possible.

The object classification circuit may include an AI according to the first aspect and/or have an algorithm for object classification which is based on a training according to the first aspect of an AI without the object classification circuit necessarily needing to have the AI, beneficially allowing computing power to be saved.

Some exemplary embodiments relate to a motor vehicle which has an object classification circuit according to the second aspect and/or the embodiments, discussed in the preceding.

The motor vehicle may denote any vehicle operated by a motor (e.g. internal combustion engine, electric machine, etc.) such as an automobile, a motorcycle, a truck, an omnibus, agricultural or forestry tractors, and the like, wherein, as described above, the present invention is not intended to be limited to a motor vehicle.

In some exemplary embodiments, an object classification according to the teachings herein may take place, for example, in street traffic to detect obstacles, other motor vehicles, street signs, and the like, wherein, as explained above, the present invention is not intended to be limited to such a type of object classification.

For example, a cellular phone, smartphone, tablet, smart glasses, and the like may have an object classification circuit, for example in the context of augmented reality, virtual reality, or other known object classification contexts.

Some exemplary embodiments relate to a system for machine learning which may be trained with a training as described herein.

The system may comprise a processor and the like on which an artificial intelligence is implemented, as it is described herein.

The training according to some embodiments may be a training method which comprises: obtaining first sensor data which are indicative of the object; obtaining second sensor data which are indicative of the object, wherein a partial symmetry exists between the first and second sensor data; detecting the partial symmetry; and creating an object class based on the detected partial symmetry.

In some exemplary embodiments, a control unit may be provided in the system which, in some exemplary embodiments, is used directly in the training. Thus, not only the first sensor data but also the second sensor data may be processed (simultaneously), wherein a label (for example, ground truth) may be the same in every iteration.

In this case, the resulting error may be summed and used for an adaptation of the AI (for example, network parameters), which may beneficially be performed in one step, allowing computing power to be saved.

Further exemplary embodiments will now be described by way of example and with reference to the attached drawings.

Specific references to components, process steps, and other elements are not intended to be limiting. Further, it is understood that like parts bear the same or similar reference numerals when referring to alternate FIGS. It is further noted that the FIGS. are schematic and provided for guidance to the skilled reader and are not necessarily drawn to scale. Rather, the various drawing scales, aspect ratios, and numbers of components shown in the FIGS. may be purposely distorted to make certain features or relationships easier to understand.

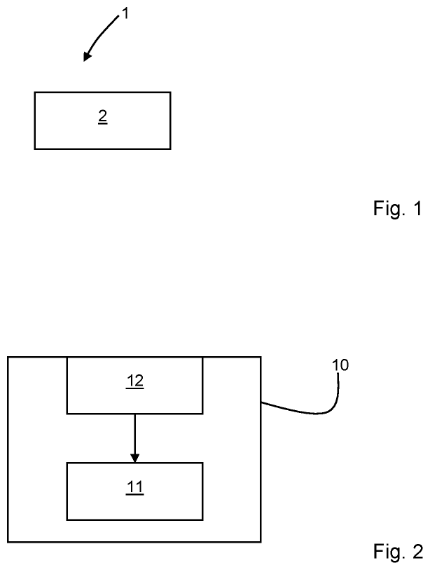

An exemplary embodiment of an object classification method 1 according to the present aspect is shown in FIG. 1 in a block diagram.

In 2, an object is classified based on sensor data from a sensor, wherein the classification is based on a training of an artificial intelligence, wherein the training comprises: obtaining first sensor data which are indicative of the object; obtaining second sensor data which are indicative of the object, wherein a partial symmetry exists between the first and second sensor data; detecting a partial symmetry; and creating an object class based on the detected partial symmetry, as described herein.

FIG. 2 shows a motor vehicle 10 which has an object classification circuit 11

In addition, the motor vehicle has a camera (sensor) 12 which provides image data (sensor data) to the object classification circuit 11, wherein the object classification circuit 11 has implemented an algorithm which is based on a training of an AI, as described herein, as a result of which the object classification circuit 11 is configured to carry out an object classification on the basis of the image data.

### LIST OF REFERENCE NUMERALS

1 Object classification method
2 Classifying an object on the basis of sensor data
10 Motor vehicle
11 Object classification circuit
12 Camera (sensor)

The invention has been described in the preceding using various exemplary embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, module or other unit or device may fulfil the functions of several items recited in the claims.

The mere fact that certain measures are recited in mutually different dependent claims or embodiments does not indicate that a combination of these measures cannot be used to advantage. Any reference signs in the claims should not be construed as limiting the scope.

What is claimed is:

1. An object classification method, comprising:
classifying an object based on sensor data from a sensor, wherein the classification is based on a training of an artificial intelligence, wherein the training comprises:
obtaining first sensor data which are indicative of the object;
obtaining second sensor data which are indicative of the object, wherein a partial symmetry exists between the first and second sensor data;
detecting the partial symmetry; and
creating an object class based on the detected partial symmetry.

2. The object classification method of claim 1, wherein the artificial intelligence comprises a deep neural network.

3. The object classification method of claim 1, wherein the second sensor data are based on a change in the first sensor data.

4. The object classification method of claim 3, wherein the change comprises at least one of the following: image data change, semantic change, and dynamic change.

5. The object classification method of claim 4, wherein the image data change comprises at least one of the following: contrast shift, color change, color depth change, image sharpness change, brightness change, sensor noise, position change, rotation, and distortion.

6. The object classification method of claim 4, wherein the semantic change comprises at least one of the following: change in illumination, change in weather conditions, and change in object characteristics.

7. The object classification method of claim 4, wherein the dynamic change comprises at least one of the following: acceleration, deceleration, motion, change in weather, and change in illumination situation.

8. The object classification method of claim 3, wherein the change is based on a sensor data change method.

9. The object classification method of claim 8, wherein the sensor data change method comprises at least one of the following: image data processing, sensor data processing, style transfer network, manual interaction, and repeated data capture.

10. The object classification method of claim 9, wherein the change is also based on a combination of at least two sensor data change methods.

11. The object classification method of claim 9, wherein the change is also based on at least one of the following: batch processing, variable training increment, and variable training weight.

12. The object classification method of claim 1, wherein the training also comprises:
detecting an irrelevant change in the second sensor data with regard to the first sensor data; and
marking the irrelevant change as an error to detect the partial symmetry.

13. The object classification method of claim 1, wherein the sensor comprises at least one of the following: camera, radar, and lidar.

14. An object classification circuit which is configured to carry out the object classification method of claim 1.

15. A motor vehicle which has the object classification circuit of claim 14.

16. The object classification method of claim 2, wherein the second sensor data are based on a change in the first sensor data.

17. The object classification method of claim 16, wherein the change comprises at least one of the following: image data change, semantic change, and dynamic change.

18. The object classification method of claim 17, wherein the image data change comprises at least one of the following: contrast shift, color change, color depth change, image sharpness change, brightness change, sensor noise, position change, rotation, and distortion.

19. The object classification method of claim 5, wherein the semantic change comprises at least one of the following: change in illumination, change in weather conditions, and change in object characteristics.

20. The object classification method of claim 5, wherein the dynamic change comprises at least one of the following: acceleration, deceleration, motion, change in weather, and change in illumination situation.
